(19) United States
(12) Patent Application Publication
(10) Pub. No.: US 2026/0312953 A1
(43) Pub. Date: Oct. 8, 2026

(54) SYSTEM AND METHOD FOR GENERATING CONFIDENCE INTERVALS OF A PREDICTED VALUE FOR AN ENTITY WHICH IS CALIBRATED BASED ON AN AD HOC ENTITY CATEGORY ASSOCIATED WITH THE ENTITY

(71) Applicant: Shopify Inc., Ottawa (CA)

(72) Inventors: Eyal Klein, Miami, FL (US); Breno Lima de Freitas, Toronto (CA); Youcef Msaid, Shawinigan (CA)

(21) Appl. No.: 19/272,043

(22) Filed: Jul. 17, 2025

Related U.S. Application Data
(60) Provisional application No. 63/781,695, filed on Apr. 1, 2025.

(51) Int. Cl. H04L 9/40; G06F 16/22

(52) U.S. Cl. CPC H04L 63/10; G06F 16/2237

(57) ABSTRACT

A computer-implemented method comprises: receiving a request for access to a resource from an entity device associated with an entity; inputting historical data associated with the entity into a value prediction model trained to output a predicted value for the entity; processing a vector embedding associated with the entity to determine an ad hoc entity category associated with the entity, wherein the ad hoc entity category includes at least one other entity similar to the entity; generating a conformal predictive distribution for the predicted value based at least in part on entities in the ad hoc entity category, where the conformal predictive distribution represents a confidence interval of the predicted value; and providing access to the resource based on the confidence interval of the predicted value.

### RELATED PATENTS AND/OR APPLICATIONS

This application claims the benefit of U.S. provisional application No. 63/781,695, titled “SYSTEM AND METHOD FOR GENERATING CONFIDENCE INTERVALS OF A PREDICTED VALUE FOR AN ENTITY WHICH IS CALIBRATED BASED AN AD HOC ENTITY CATEGORY ASSOCIATED WITH THE ENTITY”, filed on Apr. 1, 2025, and incorporated herein by reference.

### BACKGROUND

A value prediction model may be used (e.g., trained) to output a predicted value associated with a particular entity based on historical data associated with the entity. In some embodiments, the predicted value may be a forecasted value associated with a forecasted period of time while the historical data may be associated with a historical period of time. However, it may be necessary to evaluate the accuracy of the predicted values generated by the value prediction model.

### SUMMARY

Value prediction models which are trained to output predicted values (e.g., for a forecasted period of time) for a particular entity based on historical data (e.g., associated with a historical period of time) associated with that particular entity are often referred to as regression models.

To assess the value prediction model and the particular entity, it may be necessary to determine confidence intervals for the predicted value generated by the value prediction model. Such confidence intervals may be used to assess a level of error in the predicted values generated by the value prediction model and to identify potential systematic errors in the value prediction model. Such confidence intervals may also be used to assess a level of risk associated with the particular entity in situations where variations in the predicted value result from variations in the historical data associated with the particular entity. Such confidence intervals may be useful in situations where the predicted value is used to determine whether the particular entity should be allowed access to a restricted or limited resource, such as physical space, personnel, capital resources or sensitive computer network resources.

Existing methods for generating such confidence intervals for predicted values generated by regression models include generating conformal regressors or conformal predictive distributions for the predicted value. However, these existing methods are generated based on a large population of entities and do not account for the possibility that confidence intervals may change based on features associated with the entity (e.g., size, geographical location, types of goods or services sold, sophistication of users, etc.). Additionally, these existing methods do not account for the possibility that confidence intervals may also vary based on a value of the predicted value itself. Further, these existing methods often require pre-existing knowledge of the entities or manual slicing of the entities to account for different features associated with the entity. The improved method described below can solve some of these above issues.

In one embodiment, there is provided a computer-implemented method comprising: receiving a request for access to a resource from an entity device associated with an entity; inputting historical data associated with the entity into a value prediction model trained to output a predicted value for the entity; processing a vector embedding associated with the entity to determine an ad hoc entity category associated with the entity, wherein the ad hoc entity category includes at least one other entity similar to the entity; generating a conformal predictive distribution for the predicted value based at least in part on entities in the ad hoc entity category, where the conformal predictive distribution represents a confidence interval of the predicted value; and providing access to the resource based on the confidence interval of the predicted value.

The computer-implemented method may further comprise: generating vector embeddings associated with each calibration entity of a plurality of calibration entities; and processing the vector embeddings associated with each calibration entity to generate a vector index. Processing the vector embedding associated with the entity may comprise querying the vector index with the vector embedding associated with the entity.

Processing the vector embeddings associated with each calibration entity to generate the vector index may comprise determining nearest neighbors for each calibration entity to generate the vector index.

Querying the vector index with the vector embedding associated with the entity may comprise querying the vector index with the vector embedding associated with the entity to identify a k number of calibration entities of the plurality of calibration entities which are similar to the entity.

The k number of calibration entities may form the entities in the ad hoc entity category.

The entities in the ad hoc entity category may be selected based on similarity determined by vector embeddings associated with each entity of the entities in the ad hoc entity category.

The computer-implemented method may further comprise: inputting second historical data associated with a second entity into the value prediction model trained to output a second predicted value associated with the second entity; processing a second vector embedding associated with the second entity to determine a second ad hoc entity category associated with the second entity, wherein entities in the second ad hoc entity category is different from the entities in the ad hoc entity category; and generating a second conformal predictive distribution for the second predicted value based at least in part on the entities in the second ad hoc entity category, where the second conformal predictive distribution represents a second confidence interval of the second predicted value and where the second confidence interval of the second predicted value is different from the confidence interval of the predicted value.

Generating the conformal predictive distribution for the predicted value based at least in part on the entities in the ad hoc entity category may comprise generating the conformal predictive distribution for the predicted value based at least in part on corresponding predicted values associated with each entity of the entities in the ad hoc entity category. The corresponding predicted values may be outputted by the value prediction model.

The computer-implemented method may further comprise determining a rating of the entity based on the confidence interval of the predicted value.

Providing access to the resource may comprise providing access to the resource based on the rating of the entity.

Providing access to the resource may be performed automatically based on the rating of the entity.

Providing access to the resource based on the rating of the entity may be based on a comparison to a defined threshold. The computer-implemented method may further comprise: providing access to the resource when the rating of the entity is above the defined threshold; and denying access to the resource when the rating of the entity is below the defined threshold.

Determining the rating of the entity may comprise classifying the entity into one of a plurality of rating bins on at least the confidence interval of the predicted value for the entity.

Providing access to the resource based on the rating of the entity may be based on a comparison of the rating of the entity to a defined threshold. The defined threshold may be different for different rating bins of the plurality of rating bins.

The rating of the entity may correspond to a risk level of the entity.

The risk level may increase as the confidence interval of the predicted value increases.

In another embodiment, there is provided a system comprising: at least one processor; and a computer-readable medium in communication with the at least one processor. The computer-readable medium stores computer-executable instructions that, when executed, cause the at least one processor to at least: receive a request for access to a resource from an entity device associated with an entity; input historical data associated with the entity into a value prediction model trained to output a predicted value for the entity; process a vector embedding associated with the entity to determine an ad hoc entity category associated with the entity, wherein the ad hoc entity category includes at least one other entity similar to the entity; generate a conformal predictive distribution for the predicted value based at least in part on entities in the ad hoc entity category, where the conformal predictive distribution represents a confidence interval of the predicted value; and provide access to the resource based on the confidence interval of the predicted value.

The computer-readable medium may further store processor-executable instructions that cause the at least one processor to: generate vector embeddings associated with each calibration entity of a plurality of calibration entities; and process the vector embeddings associated with each calibration entity to generate a vector index. Processing the vector embedding associated with the entity may comprise querying the vector index with the vector embedding associated with the entity.

The processor-executable instructions which cause the at least one processor to query the vector index with the vector embedding associated with the entity may comprise processor-executable instructions that cause the at least one processor to query the vector index with the vector embedding associated with the entity to identify a k number of calibration entities of the plurality of calibration entities which are similar to the entity.

In another embodiment, there is provided a non-transitory computer-readable storage medium having stored thereon computer-executable instructions that, when executed, cause a computer to: receive a request for access to a resource from an entity device associated with an entity; input historical data associated with the entity into a value prediction model trained to output a predicted value for the entity; process a vector embedding associated with the entity to determine an ad hoc entity category associated with the entity, wherein the ad hoc entity category includes at least one other entity similar to the entity; generate a conformal predictive distribution for the predicted value based at least in part on entities in the ad hoc entity category, where the conformal predictive distribution represents a confidence interval of the predicted value; and provide access to the resource based on the confidence interval of the predicted value.

Determining the nearest neighbors for each calibration entity may comprise determining approximate nearest neighbors for each calibration entity.

The computer-implemented method may further comprise: inputting historical data associated with each experiment entity of a plurality of experiment entities into the value prediction model trained to output a corresponding predicted value associated with each experiment entity; processing vector embeddings associated with each experiment entity to generate a corresponding ad hoc entity category associated with each experiment entity; and generating a corresponding conformal predictive distribution for the corresponding predicted value associated with each experiment entity based at least in part on entities in the corresponding ad hoc entity category associated with that experiment entity.

The plurality of rating bins may correspond to a plurality of risk level bins.

### BRIEF DESCRIPTION OF DRAWINGS

Reference will now be made, by way of example, to the accompanying drawings which show example embodiments of the present application, and in which:

FIG. 1 is a block diagram of a system for providing access to a resource to an entity in accordance with one embodiment;

FIG. 2 is a schematic of the resource server of FIG. 1 in accordance with one embodiment;

FIG. 3 is a flowchart of computer-implemented method for generating a vector database process performed at the resource server of FIG. 2 in accordance with one embodiment;

FIG. 4 is a flowchart of computer-implemented method for generating a calibrated value prediction process performed at the resource server of FIG. 2 in accordance with one embodiment; and

FIGS. 5A-5D depict conformal predictive distributions generated for different predicted values y generated for different entities x based on ad hoc entity categories associated with the different entities x.

### DETAILED DESCRIPTION

For illustrative purposes, specific example embodiments will now be explained in greater detail below in conjunction with the figures. In some of the embodiments below, examples are presented in the context of a resource server which determines whether to provide an entity (which may be associated with an entity device) with access to a resource and how much of the resource is to be provided to the entity. However, the methods, the methodologies and systems disclosed herein are not limited to resource servers and are instead applicable to any scenario in which it is desired to determine whether to provide access to a resource to an entity, and an amount of the resources to be provided to the entity.

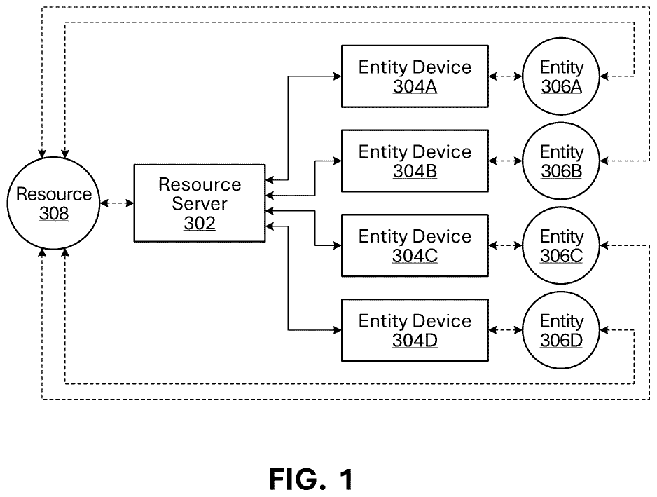

Referring to FIG. 1, a block diagram illustrating a system for providing a resource to an entity in accordance with one embodiment is shown generally at 300. The system 300 includes a resource server 302 in communication with a plurality of entity devices 304A-304D. The plurality of entity devices 304A-304D may be associated with a plurality of entities 306A-306D. The resource server 302 may determine whether to provide each entity 306 of the plurality of entities 306A-306D access to a resource 308, as well as determine an amount of the resource 308 to be allocated to that entity 306. In some embodiments, the resource server 302 may also automatically allocate the determined amount of the resource 308 to the corresponding entity 306.

The resource server 302 may comprise any computer or program that provides services to other computers, programs, or user devices either in the same computer or over a network such as the internet. As non-limiting examples, the resource server 302 may be application, communication, mail, database, proxy, fax, file, media, web, peer-to-peer, standalone, software, or hardware servers (i.e., server computers) and may use any server format known to one of ordinary skill in the art.

Reference character “304” will be used herein to refer to any one of the plurality of entity devices 304A-304D or any other entity device. An entity device 304 may be, for example, a mobile phone, or a tablet, or a laptop, or a personal computer, etc. An entity device 304 may include a processor for performing the operations of the entity device 304 (e.g., by executing instructions stored in a program memory of the entity device 304), a network interface (e.g., a transmitter/receiver with an antenna or a network interface card or a port) for communicating with the resource server 302 and a user interface (e.g., keyboard, display, and/or touchscreen). In the embodiment shown in FIG. 1, four entity devices 304A, 304B, 304C and 304D are shown; in other embodiments, a greater number or a fewer number of client devices 304 may be in communication with the resource server 302.

Reference character “306” will be used herein to refer to any one of the plurality of entities 306A-306D. For the purpose of this disclosure, the term “entity” is intended to designate anything with a distinct identity separate from other entities, and may be a physical object, an organization or a corporation (e.g., legal entity), a natural person, a natural organism (e.g., animal, bacteria, virus or micro-organism), a website (e.g., a plurality of webpages associated with a particular domain name, a plurality of webpages associated with a particular individual or corporation, etc.), a physical location, etc.

An entity device 304 may be associated with an entity 306. In some embodiments, one entity device 304 may be associated with one entity 306. For example, in embodiments where the plurality of entities 306 comprise a plurality of employees of an organization and the resource 308 comprises a plurality of secured documents as described below, the entity device 304 may be a secured personal computer associated with a particular employee of the plurality of employees. In other embodiments, one entity device 304 may be associated with multiple entities 306. For example, where the plurality of entities 306 comprises a plurality of writing instruments carried by a retail stationary store and the resource 308 comprises a number of units to stock as described below, the entity device 304 may comprise a computer system associated with the stationary store and which may be associated with all of the plurality of different writing instruments. In other embodiments, multiple entity devices 304 may be associated with one entity 306. For example, where in the plurality of entities 306 comprise a plurality of gas-oil separation plants and the resource 308 comprises space within an oil reservoir of an oil processing plant to be allotted as described below, the entity device 304 may comprise a plurality of computer systems associated with the separation plant. In the embodiment shown in FIG. 1, four entities 306A, 306B, 306C and 306D are shown, and each entity 306A-306D is associated with a respective entity device 304A-304D; in other embodiments, a greater number or a fewer number of entities 306 may be associated with the entity devices 304 and the entities 306 and entity devices 304 may be associated in the 1:1, 1: multiple, or multiple: 1 configurations described above.

A particular entity may be associated with a plurality of different features. These features may be any characteristic which describe the particular entity and which can differentiate the particular entity from other entities. For example, where the plurality of entities 306 comprises a plurality of different writing instruments in the retail store comprises a stationary store, the features may include one or more of: category of the writing instruments (e.g., pen versus pencil versus marker versus paint), brand, country of origin, dimensions of the writing instrument, dimensions of the writing instrument plus packaging, weight of the writing instrument, weight of the writing as rent plus packaging, color of the writing instrument body, color of the writing instrument ink/lead/paint, color of packaging etc. As an additional example, where the plurality of entities 306 comprises a plurality of gas-oil separation plants, features of the separation plants including one or more of: design of the separation plants (e.g., vertical separator versus horizontal separator versus spherical separator, etc.); separation functionality (e.g., oil and gas versus oil, gas and water, etc.); separation method (e.g., gravity/density, centrifugal, coalescing filters, etc.); operable pressure of the separation plants (e.g., whether the separation plant is operable to receive high, medium or low pressure fluid, etc.); physical location, etc. As an additional example, where the plurality of entities 306 comprise a plurality of employees of an organization, the features may include one or more of: age, sex, geographical location, length of employment, etc. As a final example, in embodiments where the plurality of entities 306 comprises a plurality of e-commerce stores, the features may include one or more of: category of products/services sold (e.g., footwear versus stationary products versus housekeeping services), length of operation, product variety (e.g., number of SKUs carried), etc. One skilled in the art will appreciate that different entities may be associated with widely varying features and also that a wide variety of different features can be used for describing a particular entity.

A particular entity may also be associated with historical data. This historical data may comprise any data representing past events or occurrences associated with the entity and may specifically be associated with a historical period of time. In some embodiments, the historical data associated with a particular entity may be a feature of associated with that entity. In other embodiments, the historical data associated with the particular entity may also be separate from the plurality of features associated with the particular entity. For example, where a particular entity 306 comprises a particular gas-oil separation plant, the historical data may include an oil production rate of this separation plant over a historical period of time, a total volume of oil production by this separation plant over a historical period of time, a gas production rate of this separation plant over a historical period of time, a total volume of gas production by this separation plant over a historical period of time, a water production rate of this separation plant over a historical period of time, a total volume of water produced by this separation plant over a historical period of time, etc. As a further example, where the particular entity 306 comprises a particular writing instrument with a particular SKU number, the historical data may include a number of online orders including this writing instrument over a historical period of time, a number of physical sales of this writing instrument over a historical period of time, a number of times this writing instrument has been placed into an online shopping cart over a historical period of time, a number of times that this writing instrument has been removed from the online shopping chart over a historical period of time, a number of units ordered from a supplier over a period of time, a number of restocks from a supplier over a period of time, etc. As another example, in embodiments where the particular entity 306 comprises a particular employee named J. Smith, the historical data may include a number of security attack attempts on an entity device 304 associated with J. Smith over a period of time, a number of times the entity device 304 associated the J. Smith was located off-site, etc. As a final example, where the entity 306 comprises a particular e-commerce store, the historical data may include gross merchandise value of this e-commerce store over a historical period of time, sales conversion rate over a historical period of time, average order value over a historical period of time, customer lifetime value associated with a particular customer, shopping cart abandonment rate over a historical period of time, bounce rate over a historical period of time, refund/return rate over a historical period of time, average page views of webpages associated with the particular e-commerce store over a historical period of time, a number of unique visitors to webpages associated with this e-commerce store over historical period of time, etc.

The entity device 304 may be used to submit an access request to the resource server 302 requesting access to the resource 308 on behalf of the entity (or entities) 306 associated with the entity device 304. For the purpose of this disclosure, the term “resource” is intended to designate anything which may be limited and which may be provided to the plurality of entities 306A-306D. For example, may be physical resources (e.g., minerals, fossil fuels), physical space (e.g., in an oil reservoir of an oil processing plant or a floor space in a retail store), server resources (e.g., processing power, database storage), documents and data, financial resources (e.g., investment capital, budget), human resources, etc.

In some embodiments, the historical data associated with a particular entity may specifically comprise data which can be used by the resource server 302 to determine whether access to the resource 308 should be provided to that particular entity and an amount of the resource 308 to be provided. For example, in embodiments where the entity 306 comprises a particular gas-oil separation plant, historical data representing the oil production rate over a historical period of time may be used to allocate an amount of space in the oil reservoir of the oil processing plant to that separation plant. As another example, where the entity 306 comprises a particular writing instrument, historical data representing a total number of units sold over a period of time may be used to determine how many units should be ordered. As a further example, where the entity 306 comprises a particular employee named J. Smith, historical data representing a number of phishing attempts on the entity device 304 associated with J. Smith over a historical period of time may be used to determine whether to provide J. Smith with access to a secured document. As a final example, where the entity 306 comprises a particular e-commerce store, historical data representing one or more of the gross merchandise value over a historical period of time and customer lifetime value associated with a particular customer may be used to extend financial resources to the e-commerce store.

### Resource Server 302

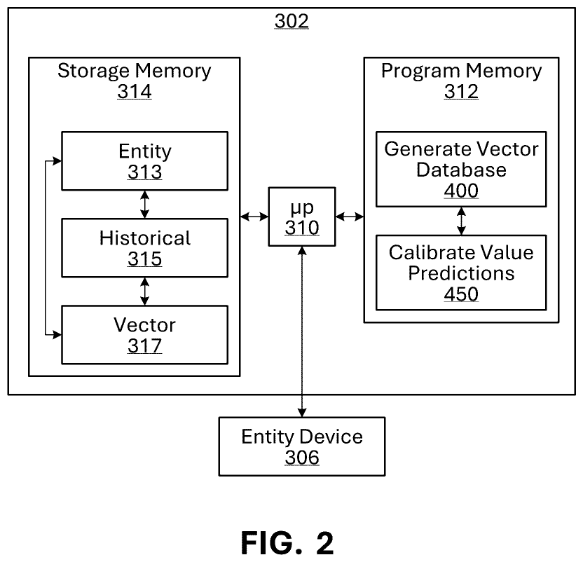

A block diagram of the resource server 302 in accordance with one embodiment is shown in FIG. 2. In the embodiment shown, the resource server 302 may include at least one resource processor 310 and a program memory 312 and a storage memory 314 in communication with the resource processor 310. Other examples of the resource server 302 may include fewer, additional or alternative components. Additionally, although only a single resource processor 310, a single program memory 312 and a single storage memory 314 is shown in FIG. 2, other embodiments of the resource server 302 may include more than one of these components.

The storage memory 314 stores information received or generated by the resource processor 310 and may generally function as an information or data store. In the embodiment shown in FIG. 2, the storage memory 314 includes an entity data store 313, a historical data store 315 and a vector data store 317; in other embodiments, the storage memory 314 may include fewer or additional datastores, and may include a model datastore which stores a vector embedding model and a value prediction model for example. The entity data store 313 may persistently or permanently store the plurality of different features associated with a particular entity of the plurality of entities 306. The historical data store 315 may persistently or permanently store the historical data associated with the particular entity of the plurality of entities 306. The vector data store 317 may store vector embeddings associated with a particular entity of the plurality entities 306 (generated as described below).

The program memory 312 stores various blocks of code (alternatively called processor, machine and/or computer executable instructions), including codes for directing the resource processor 310 to perform various processes, such as a generate vector database process 400 and a generate calibrated predicted value process 450. The program memory 312 may also store database management system codes for managing the datastores in the storage memory 314. In other embodiments, the program memory 312 may store fewer, additional or alternative codes for directing the resource processor 310 to execute additional or alternative functions. The program and storage memories 312 and 314 may each be implemented as one or a combination of a non-transitory computer.

The program and storage memories 312 and 314 may each be implemented as one or a combination of a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The term “non-transitory computer-readable medium” or “non-transitory machine-readable medium” as used herein is defined to include any type of computer-readable storage device and/or storage disk and to exclude propagating signals and to exclude transmission media.

The resource processor 310 is configured to execute codes stored in the program memory 312, to receive and transmit information to the plurality of entity devices 304A-304D, and receive and store information into the datastores of the storage memory 314. In the embodiment shown, the resource processor 310 is a server central processing unit and may be a multi-core processor. Additionally, in some embodiments, the resource processor 310, the program memory 312 and the storage memory 314 may all be located in a single data center at a single geographic location; in other embodiments, these components of the resource server 302 may be located at different geographic locations and may communicate with each other over a network, forming a cloud-based processor circuit.

### Generate Predicted Values for the Plurality of Entities 306

As briefly described above, providers of the resource 308 may wish to determine whether to allocate the resource 308 to a particular entity of the plurality of entities 306 and an amount of the resource 308 to be allocate to the particular entity. To make this determination, the providers of the resource 308 may assess the historical data and features associated with the particular entity (and which may be relevant for the resource 308), as the historical data and features may be indicative of the amount of the resource 308 that particular entity needs in the future and potential risks in providing the resource 308 to that particular entity.

In this regard, in some embodiments, the providers of the resource 308 may assess the historical data and/or features associated with a particular entity to generate a predicted value y. In some embodiments, the providers of the resource 308 may assess all historical data and/or features associated with the particular entity. In other embodiments, the provider of the resource 308 may specifically assess the historical data and/or features associated with the particular entity that is related to, or relevant to, the resource 308. For example, in embodiments where the entity 306 comprises a particular gas-oil separation plant x and the resource 308 comprises space in the oil reservoir of the oil processing plant, the historical data assessed may specifically comprise one or more of the oil production rate over a historical period of time and the total volume of oil production over a historical period of time, while disregarding the gas production rate, the water production rate, a number of personnel at the gas-oil separation plant, etc. Similarly, in embodiments with the entity 306 comprises a particular writing instrument x and the resource 308 comprises a number of the to be stocked, the historical data assessed may specifically comprise the total number of units sold over a period of time, while disregarding the historical number of units ordered from the supplier.

The historical data and/or features may be inputted into a value prediction model. The value prediction model may be trained to output a predicted value y for the entity 306 during a future period of time or a forecasted period of time. This predicted value y can be used as a proxy to determine future need or entitlement of that particular entity to the resource 308. For example, where the entity 306 comprises the particular gas-oil separation plant and the resource 308 comprises space in the oil reservoir of the oil processing plant to be allocated to that particular separation plant, the value prediction model may generate a predicted value y corresponding to a predicted oil production rate (e.g., in barrels per day) of the particular separation plant during a future period of time, which may be used to determine how much of the oil reservoir needs to be allocated to that particular separation plant. As a further example, where the entity 306 comprises a particular writing instrument and the resource 308 comprises a number of units to be stocked, the value prediction model may generate a predicted value y corresponding to a predicted number of units to be sold over a future period of time.

One skilled in the art will appreciate that the value prediction model may be any statistical model or a regression machine learning model which can be used to generate a predicted value. For example, the value prediction model may comprise one or more of a linear regression model and variants thereof, a polynomial regression model (e.g., logarithmic), a k-nearest neighbors (KNN) model, a support vector machine (SVM) model, a random forest model, a boosted forest model, a neural network model, etc. The value prediction model may also specifically comprise a time series regression model (e.g., Facebook Prophet involving a long short-term memory (LSTM) recurrent neural network model, ARIMA involving an autoregression model). One skilled in the art will appreciate alterative and specific regression models which may be used to predict different values associated with different and are possible.

However, the predicted values y generated by the value prediction model may not always correspond to actual values Y which are generated by the entities 306 during the future period of time. Some of these prediction errors may be due to factors associated with the value prediction model, including poor data quality (e.g., lack of historical data associated with a particular entity), over fitting or under fitting of the value prediction model to a training set, failing to account for seasonality or outliers in the historical data, etc. Some of these prediction errors may also be due to factors associated with the particular entity 306 itself, such as true variations in the historical data associated with the particular entity 306 (e.g., a level risk associated with the particular entity).

One skilled in the art will appreciate that there are various methods to determine such prediction errors, including a mean absolute error (MAE), a mean squared error (MSE), a root mean squared error (RMSE), a standard error of the regression model, etc. One method of determining prediction errors may involve generating confidence intervals for the predicted value, whereby the confidence interval may represent a range of possible values and a confidence level for the predicted value. Existing methods for generating such confidence intervals include generating a conformal regressor for the predicted value y (e.g., an indictive conformal regressor or a split conformal regressor) or generating a conformal predictive distribution for the predicted value y (e.g., an inductive conformal predictive (ICP) distribution, a split conformal predictive (SEP) distribution or a Mondrian conformal predictive distribution such as that described in Bostrom, H., Johansson, U. & Löfström, T. (2021). Mondrian conformal predictive distributions. Proceedings of the Tenth Symposium on Conformal and Probabilistic Prediction and Applications, in Proceedings of Machine Learning Research, 152:24-38, incorporated by reference in its entirety herein). However, these existing methods are generated based on a large population of entities 306 and do not account for the possibility that confidence intervals for a predicted value y associated with a particular entity 306 may change based on features and/or historical data of that particular entity 306. Additionally, these existing methods do not account for the possibility that confidence intervals may also vary based on a value of the predicted value itself. Further, these existing methods often require pre-existing knowledge of the entities 306 or manual categorization of the entities 306.

In contrast, the methodology described below involves generating confidence intervals for a predicted value y for a particular entity x which is calibrated using a conformal predictive distribution generating using an entity category associated with that particular entity x. The entity category may include other entities in the plurality of entities 306 that are similar to the particular entity x. Generating the confidence interval based on a conformal predictive distribution tailored to a particular entity category may produce confidence intervals which are more tailored to features of the particular entity x and which can account for different type of errors and risks that are associated with different types of entities. As a more specific example, where the plurality of entities 306 comprises the plurality of gas-oil separation plants, the corresponding value prediction model may over predict the oil production rate for separation plants which use a horizontal separator but under predict the oil production rate for separation plants which use a spherical separator. Generating entity categories (and corresponding Mondrian conformal predictive distributions) which separate the separation plants that use horizontal separators from those that use spherical separators can generate more relevant confidence intervals for the predicted value y outputted by the value prediction model for such separation plants. As an additional example, where the plurality of entities 306 comprise the plurality of writing instruments, the corresponding value prediction model may over predict the number of units sold per week for writing instruments which have blue ink but under predict the number of units sold per week for writing instruments which have red ink. Generating entity categories which separate writing instruments which have blue ink from those that have red ink can again generate more relevant confidence intervals for the predicted values y outputted for such writing instruments.

As described below, the entity category associated with a particular entity x may be automatically generated by the resource server 302 on an ad hoc basis (i.e., as needed for each entity) based on a vector index (e.g., retrieved from the vector data store 317) which describes the plurality of entities 306. This may conserve computing resources as the entity categories are determined on an ad hoc basis, without needing to spend computing resources to categorize or classify every single entity of the plurality of entities 306 into a pre-existing category. Further, generating the ad hoc entity category for a particular entity x on a real-time basis may also improve accuracy and relevance of the ad hoc entity category, the particular entity x is only categorized when the predicted value y for the particular entity x is required and is categorized on the basis of the most recent historical data and/or features associated with that particular entity x.

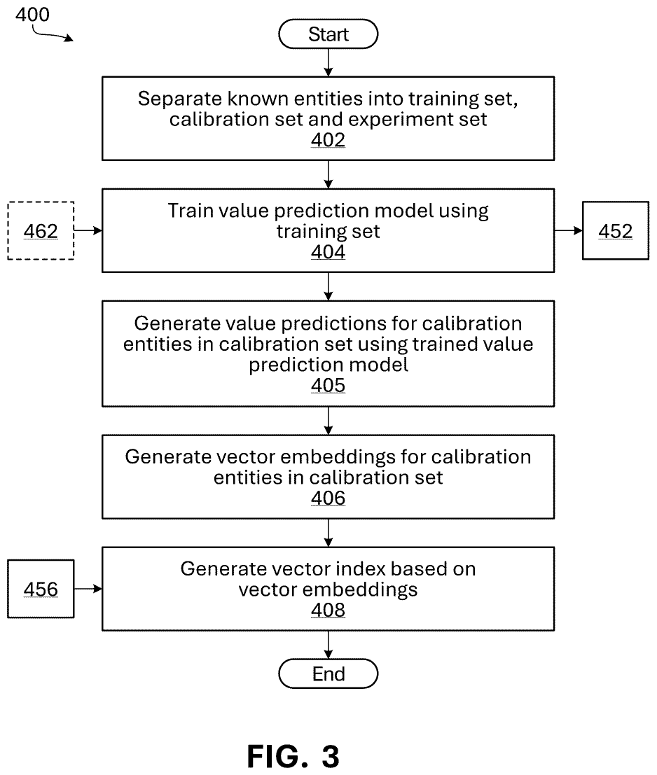

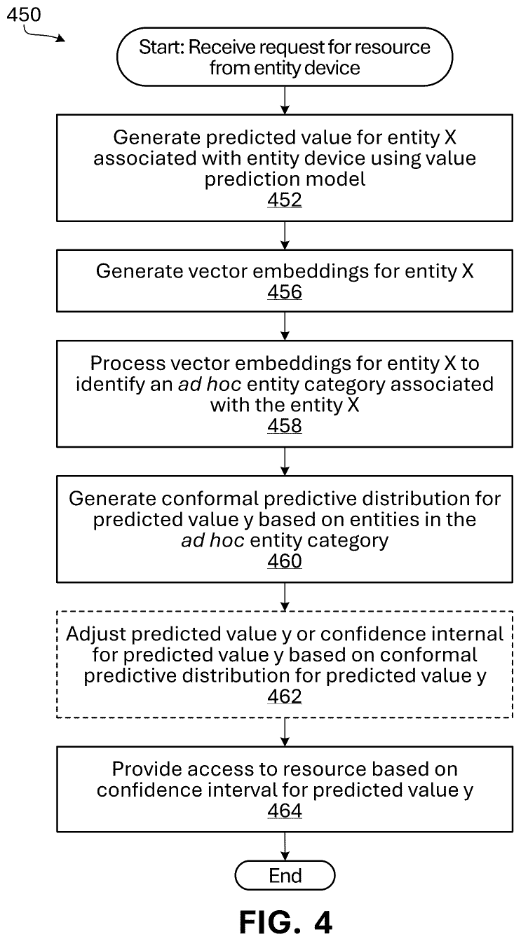

To implement this methodology to generate confidence intervals for a predicted value y generated for a particular entity x which are calibrated based on an ad hoc entity category associated with that particular entity x, the resource processor 310 may execute the generate vector database process 400 shown in FIG. 3 and the generate calibrated predicted value process 450 shown in FIG. 4.

### Generate Vector Database Process 400

The generate vector database process 400 may generally involve directing the resource processor 310 to generate a vector database which can be used to store vector embeddings describing the plurality of entities 306 based on the features and/or the historical data associated with the plurality entities 306 and which allow retrieval of entities of the plurality of entities 306 which are similar to a particular entity x. In the embodiment shown in FIG. 3, the generate vector database process 400 comprises machine, processor and/or computer readable/executable instructions stored in the program memory 312 for execution by the resource processor 310; in other embodiments, the generate vector database process 400 may comprise machine, processor and/or computer-readable instructions alternatively stored on other non-transitory computer readable storage medium such as a CD-ROM, a floppy disk, a hard drive, a DVD, a Blu-ray disk or another component associated with the resource server 302; in yet other embodiments, the generate vector database process 400 and/or parts thereof could alternatively be executed by a device other than the resource processor 310 and/or embodied in firmware or dedicated hardware.

In the embodiment shown, the generate vector database process 400 may begin at block 402, which may include processor-executable codes directing the resource processor 310 to separate a plurality of known entities into a training set, a calibration set and an experiment set. Each known entity of the plurality of known entities are ground labeled with an actual value Y. This actual value Y which can be used to train the value prediction model, to generate confidence intervals for the predicted values generated by the value prediction model, and to adjust the predicted value y or the confidence intervals of the predicted value y as described below.

For example, for a dataset including an n number of known entities (e.g., gas-oil separation plants or writing instruments), block 402 may direct the resource processor 310 to generate a training set Zₜ including an p number of training entities xₜ₁ . . . xₜₚ, a calibration set Z_{c} including a q number of calibration entities x_{c1} . . . . x_{cq} and an experiment set Zₑ including a r number of experiment entities xₑ₁ . . . . xₑᵣ. The division of the plurality of entities 306 into the training set Zₜ, the calibration set Z_{c} and the experiment set Zₑ may be random such that any entity of the n number of known entities may be grouped into the training set Zₜ, the calibration set Z_{c} or the experiment set Zₑ interchangeably; however, one particular entity may be placed in only one of the training, calibration and experiment sets. In some embodiments, the p number of training entities in the training set Zₜ may represent approximately 60% of the total n number of known entities, the q number of calibration entities in the calibration set Z_{c} may represent approximately 10% of the total n number of known entities, and the r number of experiment entities in the experiment set Z_{c} may represent approximately 30% of the total n number of known entities. In other embodiments, the q number of calibration entities may represent anywhere between 5% and 30% of the total n number of entities.

The generate vector database process 400 may then continue to block 404, which may include processor-executable codes directing the resource processor 310 to use the training entities xₜ₁ . . . . xₜₚ in the training set Zₜ to train the value prediction model. Briefly, as described above, the value prediction model comprise any may be any statistical model or a regression machine learning model which can be used to generate a predicted value. Block 404 may direct the resource processor 310 to train the value prediction model by inputting the historical data and/or the features associated with the training entities xₜ₁ . . . . xₜₚ which are ground labelled with training actual values Yₜ into a regression model to iteratively generate and optimize coefficients which enable the regression model to generate training predicted values yₜ based on input of the historical data and/or the features.

As a more specific example of training based on historical data, where the plurality of training entities xₜ₁ . . . . xₜₚ comprise a plurality of gas-oil separation plants, block 404 may direct the resource processor 310 to input historical data comprising one or more of: the oil production rate (in barrels per day) of the plurality of gas-oil separation plants over a historical period of time (e.g., averaged over a period of time including one or more of: 1 hour, 12 hours, 24 hours, 24 hours, last three days, last seven days, etc. (i.e., moving average); averaged over a period of time including one or more of: same hours in a day as a forecasted period of time, same days in a week as the forecasted period of time, same days in a calendar year as the forecasted period of time, etc.), combined with an training actual value Yₜ representing an actual oil production rate during the forecasted period of time, into the value prediction model to train the value prediction model to output a predicted value yₜ corresponding to a predicted oil production rate for the forecasted period of time. As a further example, where the plurality of training entities xₜ₁ . . . . xₜₚ comprise a plurality of writing instruments, block 404 may direct the resource processor 310 to inputting the historical data comprising a total number of units sold over a historical period of time (e.g., including one or more of: 1 hour, 12 hours, 24 hours, 24 hours, last three days, last seven days, last 30 days, etc. (i.e., moving average); averaged over a period of time including one or more of: same hours in a day as a forecasted period of time, same days in a week as the forecasted period of time, same days in a calendar year as the forecasted period of time, etc.), combined with an training actual value Yₜ representing an number of units sold during a forecasted period of time, into the value prediction model to train the value prediction model to output a predicted value yₜ corresponding to a predicted number of units to be sold over the forecasted period of time.

As a more specific example of training based on features, where the plurality of training entities xₜ₁ . . . . xₜₚ comprise the plurality of gas-oil separation plants, block 404 may involve inputting the features comprising one or more of design, separation functionality, separation method, operable pressure of the separation plants, physical location, etc., combined with the training actual value Yₜ representing an actual oil production rate during a forecasted period of time, into the value prediction model to train the value prediction model to output a predicted value yₜ corresponding to a predicted oil production rate for the forecasted period of time. As a further example, where the plurality of training entities xₜ₁ . . . . xₜₚ comprise the plurality of writing instruments, block 404 may involve inputting features comprising one or more of category, brand, country of origin, dimensions, weight, color, etc., combined with an training actual value Yₜ representing an number of units sold during a forecasted period of time, into the value prediction model to train the value prediction model to output a predicted value yₜ corresponding to a predicted number of units to be sold over the forecasted period of time.

The generate vector database process 400 then continues to block 405, which may include processor-executable codes directing the resource processor 310 to generate a plurality of calibration predicted values y_{c1} . . . . y_{cq} for the plurality of calibration entities x_{c1} . . . . x_{cq} in the calibration set Z_{c} using the value prediction model trained at block 404.

For example, block 405 may direct the resource processor 310 to input the historical data and/or the features associated with the plurality of calibration entities x_{c1} . . . . x_{cq} into the value prediction model trained at block 404 to output the corresponding plurality of calibration predicted values y_{c1} . . . y_{cq}. In particular, block 405 may direct the resource processor 310 to (A) use the same value prediction model as that trained on the training set Zₜ at block 404 and (B) generate the plurality of calibration predicted values y_{c1} . . . y_{cg} by inputting the same historical data and/or features associated with the plurality of calibration entities x_{c1} . . . . x_{cq} as that used to train the value prediction model at block 404. As a more specific example, referring to Table 3 below, in embodiments where the plurality of calibration entities x_{c1} . . . . x_{cq} comprise gas-oil separation plants, block 405 may direct the resource processor 310 to input, into the value prediction model: (i) historical data comprising one or more of the oil production rate over two different historical periods of time (e.g., last seven days and same days in a calendar year as the forecasted period of time, etc.) and/or (ii) features comprising one or more of the design, separation functionality, separation method, operable pressure of the separation plants, physical location, etc. Based on this historical data and/or features, the value prediction model may be trained to output a calibration predicted value y_{c} corresponding to a predicted oil production rate over the forecasted period of time for each calibration entity x_{c}. As can be seen from Table 3 below, as the plurality of calibration entities x_{c1} . . . . x_{cq} are a part of the plurality of known entities, each of the plurality of calibration entities x_{c1} . . . . x_{cq} also includes a corresponding calibration actual value Y_{c1} . . . . Y_{cg} corresponding to the actual oil production rate over the forecasted period of time.

TABLE 3
Example calibration entities and predicted values

| | | Historical data: oil | | |
|---|---|---|---|---|
| | Features: design, | production rate last | | |
| | functionality, method, | seven days, oil | Calibration | Calibration |
| Calibration | pressure, physical | production rate same | actual value | predicted |
| entity q | location [ . . . ] | seven days, [ . . . ] | Y_{c} | value y_{c} |
| 1 | vertical, oil and gas, | 870 bpd, 850 bpd, | 890 bpd | 880 bpd |
| | gravity/density, high | [ . . . ] | | |
| | pressure, | | | |
| | Uthmaniyah 1 [ . . . ] | | | |
| 2 | spherical, oil and gas, | 740 bpd, 1700 bpd, | 800 bpd | 780 bpd |
| | gravity/density, high | [ . . . ] | | |
| | pressure, | | | |
| | Uthmaniyah 4 [ . . . ] | | | |
| 3 | vertical, oil and gas, | 1450 bpd, 800 bpd, | 1270 bpd | 1580 bpd |
| | centrifugal, medium | [ . . . ] | | |
| | pressure, Shedgum | | | |
| | [ . . . ] | | | |
| 4 | Horizontal, oil and | 600 bpd, 870 bpd, | 920 bpd | 710 bpd |
| | gas and water, filter, | [ . . . ] | | |
| | very high pressure, | | | |
| | Permian 14 [ . . . ] | | | |

[ . . . ]

As a further example, in embodiments where the plurality of calibration entities x_{c1} . . . . x_{cq} comprise the plurality of writing instruments and the resource 308 comprises a number of units to be stocked at a particular retail store, block 405 may direct the resource processor 310 to input, into the value prediction model: (A) historical data comprising a total number of units sold over a historical period of time and (B) features comprising one or more of category, brand, country of origin, dimensions, weight, color, etc. Based on this historical data and/or feature data, the value prediction model may be trained to output a calibration predicted value y_{c} corresponding to a predicted number of units to be sold over a forecasted period of time for each calibration entity x_{c}.

The generate vector database process 400 may then continue to block 406, which may include processor-executable codes directing the resource processor 310 to generate vector embeddings for each calibration entity x_{c1} . . . . x_{cg} of the calibration set Z_{c}. Block 406 may further direct the resource processor 310 to store the generated vector embeddings in the vector data store 317.

In some embodiments, block 406 may direct the resource processor 310 to generate the vector embeddings for the other populations in the n number of known entities (e.g., also for each training entity xₜ₁ . . . . xₜₚ of the training set Zₜ and/or each experiment entities xₑ₁ . . . . xₑᵣ of the experiment set Zₑ). However, generating the vector embeddings for only the calibration set Z_{c} at block 406 may reduce computing resources required to generate an initial vector index (described below at block 408), as only the features and/or the historical data associated with the calibration entities x_{c1} . . . . x_{cq} need to be analysed to generate the initial vector index. Further, in some embodiments, the vector embeddings for the experiment entities xₑ₁ . . . . xₑᵣ and the vector embeddings for inference entities x_{f} may be generated at block 456 (described below); these additional vector embeddings added to the initial vector index to generate a modified vector index after block 456 as applicable and as described below.

Block 406 may direct the resource processor 310 to generate the vector embeddings for a particular calibration entity x, based on features associated therewith (e.g., retrieved from the entity data store 313). As described above, a feature of an entity may be any characteristic which can describe a particular entity and which can be used to differentiate the particular entity from other entities. As a more specific example, referring to Table 1 below, where the plurality of entities 306 comprise the plurality of gas-oil separation plants, the vector embeddings may be generated based on the features of the separation plants including one or more of: design (e.g., vertical separator versus horizontal separator versus spherical separator, etc.); separation functionality (e.g., oil and gas versus oil, gas and water, etc.); separation method (e.g., gravity/density, centrifugal, coalescing filters, etc.); operable pressure of the separation plants (e.g., high, medium or low pressure fluid, etc.); physical location, etc. As another example, where the plurality of entities 306 comprise the plurality of writing instruments, the vector embeddings may be generated based on features of the writing instruments including one or more of: category of the writing instruments (e.g., pen versus pencil versus marker versus paint), brand of the writing instruments, country of origin, dimensions, weight, color, etc. One skilled in the art will appreciate that different entities may be associated with widely varying features and also that a wide variety of different features can be used for describing a particular entity.

TABLE 1
Example calibration entities and vector embeddings

| | Features: design, functionality, | Historical data: oil | |
|---|---|---|---|
| Calibration | method, pressure, physical location | production rate, gas | Vector |
| entity q | [ . . . ] | production rate, [ . . . ] | embedding |
| 1 | vertical, oil and gas, gravity/density, | 870 bpd, 1000 scfd, | [1.2, −9.0, −0.8, |
| | high pressure, Uthmaniyah 1 [ . . . ] | [ . . . ] | 7.2, . . . ] |
| 2 | spherical, oil and gas, | 740 bpd, 1800 scfd, | [8.9, −7.8, −1.2, |
| | gravity/density, high pressure, | [ . . . ] | 7.7, . . . ] |
| | Uthmaniyah 4 [ . . . ] | | |
| 3 | vertical, oil and gas, centrifugal, | 1450 bpd, 800 scfd, | [54.0, 8.1, −6.3, |
| | medium pressure, Shedgum [ . . . ] | [ . . . ] | 98.2, . . . ] |
| 4 | horizontal, oil and gas and water, | 150 bpd, 70800 scfd, | [−963.8, −96.1, |
| | filter, very high pressure, Permian | [ . . . ] | 0.3, −0.2, . . . ] |
| | 14 [ . . . ] | | |

[ . . . ]

Block 406 may also direct the resource processor 310 to generate the vector embeddings for a particular calibration entity x, based on historical data associated therewith (e.g., retrieved from the historical data store 315). As described above, historical data associated with an entity may be any data representing past events or occurrences during a historical period of time. As a more specific example of possible historical data, referring to Table 1 above, where the plurality of entities 306 comprises the plurality of gas-oil separation plants, the vector embeddings may be generated based on historical data including one or more of: oil production rate over a historical period of time; a gas production rate over a historical period of time, etc. As another example, where the plurality of entities 306 comprise the plurality of writing instruments, the vector embedding can be generated based on historical data including one or more of: a number of online orders or physical sales over a historical period of time, a number of times where a corresponding writing assignment has been placed into or removed from an online shopping cart over a historical period of time, etc. One skilled in the art will appreciate that different entities may be associated with widely varying historical data and that a wide variety of historical data can be associated with a particular entity.

Block 406 may involve any vector embedding methodology known to one skilled in the art. For example, block 406 may involve inputting the features and the historical data associated with a particular entity into a vector embedding model. The vector embedding model may be trained to output vector embeddings associated with a particular entity based on the features and/or the historical data associated with that particular entity described above. The vector embedding model may be a machine learning model and may specifically involve a temporal embedding model, and may comprise a LSTM model, a transformer-based model (e.g., Informer, Spacetimeformer), a fast Fourier transform (FFT) model, a temporal knowledge graph, etc. One skilled in the art will appreciate that different models are possible for generating vector embeddings based on different features and different historical data, and that a wide variety of such models may be used at block 406.

In some embodiments, block 406 may also direct the resource processor 310 to post-process the vector embeddings generated by the vector embedding model to reduce dimensionality of the generated vector embeddings. For example, block 406 may also direct the resource processor 310 to process the generated embedding with a dimensionality reduction algorithm (e.g., principal component analysis, uniform manifold approximation and projection (UMAP) algorithm, t-distributed stochastic neighbor embedding (t-SNE) algorithm, etc.). One skilled in the art will appreciate that different vector embeddings may processed with different dimensionality reduction algorithms and that a wide variety of such algorithms may be used at block 406.

The generate vector database process 400 may then continue to block 408, which may include processor-executable codes directing the resource processor 310 to generate an initial vector index for the vector embeddings generated at block 406. Block 408 may also direct the resource processor 310 to store the initial vector index in the vector data store 317.

Block 408 may involve any vector indexing methodology known to one skilled in the art. Block 408 may specifically direct the resource processor 310 to generate a vector index that allows for rapid querying of the vector embeddings indexed thereby. For example, in some embodiments, block 408 may involve generating a tree-based index for the vector embeddings generated at block 406 (e.g., Approximate Nearest Neighbors (ANNOY), Multi-Stage Tree Graph (MSTG)). In other embodiments, block 408 may instead involve generating a hash-based index, a cluster-based index (e.g., Inverted file (IVF) and variants thereof) or a graph-based index (e.g., by using hierarchal navigable small world (e.g., Hierarchical Navigable Small World (HNSW), (C)UDA (A)NN (GRA)ph (CAGRA), VAMANA). One skilled in the art will appreciate that different vector indexing algorithms may be appropriate for different vector embeddings and that a wide variety of such algorithms may be used block 408. The generate vector database process 400 may then end.

### Generate Calibrated Predicted Value Process 450

The generate calibrated predicted value process 450 may generally involve directing the resource processor 310 to generate a predicted value y for a corresponding entity x in response to request to access the resource 308 received from the entity device 304 associated with the corresponding entity x. The generate calibrated predicted value process 450 may then involve generating a confidence interval for that predicted value y, where the confidence interval is calibrated based on features and/or historical data associated with corresponding entity x. In the embodiment shown in FIG. 4, the generate calibrated predicted value process 450 comprises machine, processor and/or computer readable/executable instructions stored in the program memory 312 for execution by the resource processor 310; in other embodiments, the generate calibrated predicted value process 450 may comprise machine, processor and/or computer-readable instructions alternatively stored on other non-transitory computer readable storage medium such as a CD-ROM, a floppy disk, a hard drive, a DVD, a Blu-ray disk or another component associated with the resource server 302; in yet other embodiments, the generate calibrated predicted value process 450 and/or parts thereof could alternatively be executed by a device other than the resource processor 310 and/or embodied in firmware or dedicated hardware.

In the embodiment shown, the generate calibrated predicted value process 450 may begin at block 452, which may include processor-executable codes directing the resource processor 310 to generate predicted value y for a corresponding entity x based on the historical data and/or the features associated with a corresponding entity x. As described above, this predicted value y may be used as a proxy for determining future entitlement or allotment of the resource 308 to the corresponding entity x. The entity x may comprise an experiment entity xₑ of the plurality of experiment entities xₑ₁ . . . . xₑᵣ in the experiment set Zₑ, in which case block 452 may generate a corresponding experiment predicted value yₑ. The entity x may comprise an inference entity x_{f}, in which case block 452 may generate a corresponding inference predicted value y_{f}. As described above, the experiment entity xₑ is a part of the known entities and thus has an experiment actual value Yₑ that can be used to assess errors in the experiment predicted value yₑ generated at this block 452 or a conformal predictive distribution for the experiment predicted value yₑ generated at block 460 described below. However, inference entity x_{f} does not have any actual values associated therewith.

For example, block 452 may direct the resource processor 310 to input the historical data and/or the features associated with a corresponding entity x into the value prediction model trained to output the corresponding predicted value y at block 404. In particular, block 452 direct the resource processor 310 to (A) use the same value prediction model as that trained on training set Zₜ at block 404 and used to generate the plurality of calibration predicted values y_{c1} . . . y_{cg} at block 405 and (B) generate predicted value y by inputting the same historical data and/or features for the corresponding entity x as that used to train the value prediction model at block 404 and to generate the plurality of calibration predicted values y_{c1} . . . y_{cq} at block 405. This allows the plurality of calibration predicted values y_{c1} . . . y_{cq} (generated at block 405) to be used when generating a conformal predictive distribution for predicted value y as described at block 460 below.

As a more specific example, referring to Table 2 below, where the entity x comprises a particular gas-oil separation plant and the resource 308 comprises space in the oil reservoir of the oil processing plant to be allocated to that particular separation plant, block 452 may involve inputting, into the value prediction model: (A) historical data comprising one or more of the oil production rate over two different historical periods of time (e.g., last seven days and same days in a calendar year as the forecasted period of time, etc.) and/or (B) features comprising one or more of the design, separation functionality, separation method, operable pressure of the separation plants, physical location, etc. Based on this historical data and/or feature data, the value prediction model may be trained to output a predicted value y corresponding to a predicted oil production rate over the forecasted period of time for that particular separation plant. As can be seen from Table 2 below, in situations where the entity x comprises the experiment entity xₑ, an experiment actual value Yₑ corresponding to the actual oil production rate of a particular separation plant over the forecasted period of time is also known.

TABLE 2
Example experiment entities and inference entity and predicted values

| | | | Historical data: oil | | |
|---|---|---|---|---|---|
| | | Features: design, | production rate | | Experiment |
| | | functionality, | last seven days, oil | | predicted |
| | | method, pressure, | production rate | Experiment | value yₑ or |
| Experiment | Inference | physical location | same seven days, | actual | predicted |
| entity r | entity f | [ . . . ] | [ . . . ] | value Yₑ | value y_{f} |
| 1 | | horizontal, oil and | 970 bpd, 690 ppb | 780 bpd | 680 bpd |
| | | gas and water, | [ . . . ] | | |
| | | centrifugal, very high | | | |
| | | pressure, Permian | | | |
| | | 16 [ . . . ] | | | |
| 2 | | horizontal, oil and | 640 bpd, 125 bpd | 210 bpd | 340 bpd |
| | | gas and water, | [ . . . ] | | |
| | | gravity/density, high | | | |
| | | pressure, | | | |
| | | Ponchatoula 4 [ . . . ] | | | |
| 3 | | vertical, oil and gas, | 850 bpd, 969 bpd | 950 bpd | 840 bpd |
| | | gravity/density, | [ . . . ] | | |
| | | medium pressure, | | | |
| | | Uthmaniyah 1 [ . . . ] | | | |
| 4 | | horizontal, oil and | 980 bpd, 1080 bpd | 980 pbd | 690 bpd |
| | | gas and water, filter, | [ . . . ] | | |
| | | very high pressure, | | | |
| | | Permian 18 [ . . . ] | | | |

[ . . . ]

| | | | |
|---|---|---|---|
| 1 | spherical, oil and | 1400 bpd, 1480 bpd | 1450 bpd |
| | gas, gravity/density, | [ . . . ] | |
| | low pressure, | | |
| | Uthmaniyah 6 [ . . . ] | | |

As a further example, where the entity x comprises the writing instrument and the resource 308 comprises a number of units to be stocked at a particular retail store, block 452 may direct the resource processor 310 to input, into the value prediction model: (A) historical data comprising a total number of the writing instrument sold over a historical period of time and (B) features comprising one or more of category, brand, country of origin, dimensions, weight, color, etc. Based on this historical data and/or feature data, the value prediction model may be trained to output a predicted value y corresponding to a predicted number of units to be sold over a forecasted period of time. In situations where the entity x comprises the experiment entity xₑ, an experiment actual value Yₑ corresponding to the actual number of units of a particular writing instrument sold over the forecasted period of time is also known.

The generate calibrated predicted value process 450 then continues to block 456, which may include processor-executable codes directing the resource processor 310 to generate a vector embedding for the entity x (e.g., a particular experiment entity xₑ or a particular inference entity x_{f}) in a manner similar to block 406 of the generate vector database process 400 described above. For example, block 456 may also direct the resource processor 310 to generate the vector embeddings for the entity x based on features associated with that entity x and/or the historical data associated with that entity x.

In particular, block 456 may direct the resource processor 310 to generate the vector embeddings for the entity x utilizing the same vector embedding methodology used to generate the vector embeddings for the plurality of calibration entities x_{c1} . . . . x_{cq} at block 406. This allows the resource processor 310 to use the vector embeddings generated for the entity x to query the vector index generated at block 408 to identify calibration entities that may be similar the entity x. This may also allow the resource processor 310 to store the vector embeddings generated for the entity x together with the vector embeddings generated for the plurality of calibration entities x_{c1} . . . . x_{cq} to further populate the vector index (e.g., to modify the initial vector index generated at block 408 and to generate the modified vector index) usable for searching the plurality of entities 306. In this regard, block 456 may further direct the resource processor 310 to store the generated vector embeddings for the entity x in the vector data store 317. In some embodiments, block 456 may direct the resource processor 310 to modify the initial vector index generated at block 406 with the vector embeddings generated for the entity x to generate the modified vector index.

As a more specific example, referring to Table 4 reproduced below, where the plurality of entities 306 comprise a plurality of gas-oil separation plants and the vector embedding methodology performed for the plurality of calibration entities x_{c1} . . . . x_{cq} at block 406 involved generating vector embeddings using an LSTM model or a UMAP to process: (i) features of the separation plants including one or more of design, separation functionality, separation method, operable pressure, physical location, etc.; and (ii) historical data of the separation plants including one or more of the oil production rate over the last seven days and the gas production rate over the last seven days, etc., block 456 may direct the resource processor to use the same vector embedding methodology for the entity x.

TABLE 4
Example experiment entities and vector embeddings

| | | Features: design, | | |
|---|---|---|---|---|
| | | functionality, method, | Historical data: oil | |
| Experiment | Inference | pressure, physical location | production rate, gas | Vector |
| entity r | entity f | [ . . . ] | production rate, [ . . . ] | embedding |
| 1 | | horizontal, oil and gas and | 970 bpd, 20050 scfd, | [−1003.8, −10.1, |
| | | water, centrifugal, very high | [ . . . ] | 7.9, −0.5, . . . ] |
| | | pressure, Permian 16 [ . . . ] | | |
| 2 | | horizontal, oil and gas and | 640 bpd, 9930 scfd, | [−763.8, 10.1, |
| | | water, gravity/density, high | [ . . . ] | 0.9, −0.8, . . . ] |
| | | pressure, Ponchatoula 4 [ . . . ] | | |
| 3 | | vertical, oil and gas, | 850 bpd, 800 scfd, | [44.7, 10.6, −4.9, |
| | | gravity/density, medium | [ . . . ] | 160.2, . . . ] |
| | | pressure, Shedgum [ . . . ] | | |
| 4 | | horizontal, oil and gas and | 980 bpd, 10800 scfd, | [−990.8, −93.1, |
| | | water, filter, very high | [ . . . ] | 10.3, −15.9, . . . ] |
| | | pressure, Permian 18 [ . . . ] | | |

[ . . . ]

| | | | |
|---|---|---|---|
| 1 | spherical, oil and gas, | 1400 bpd, 600 scfd | [47.4, 17.0, −9.1, |
| | gravity/density, low | | 250.8, . . . ] |
| | pressure, Uthmaniyah 6 [ . . . ] | | |

The generate calibrated predicted value process 450 then continues to block 458, which may include processor-executable codes directing the resource processor 310 to query the vector index (e.g., generated at block 408 or modified during a previous instance of block 456) with the vector embedding of a particular entity x (e.g., generated at block 456) to identify a k number of entities xₛ (e.g., xₛ₁ . . . . xₛₖ) which are similar to that particular entity x. In some embodiments, the similar entities xₛ may comprise only calibration entities (e.g., in embodiments where the vector index queried comprises the initial vector index generated at block 408 only including vector embeddings of the plurality of calibration entities x_{c1} . . . . x_{cq}). In other embodiments, the similar entities x, may comprise calibration entities, experiment entities and inference entities (e.g. in embodiments where the initial vector index has been modified to include the vector embeddings of at least one experiment entity or at least one inference entity during a previous instance of block 456).

As a more concrete example, referring to Tables 1 and 4 above, where the plurality of entities 306 comprise the plurality of gas-oil separation plants, the resource processor 310 may determine that experiment entity 3 (e.g., xₑ₃ in Table 4) is similar to calibration entities 1, 2 and 3 (e.g., x_{c1}, x_{c2}, and x_{c3} in Table 1) on the basis of the vector embeddings associated therewith, and generally representing that the experiment entity 4 and the calibration entities 1, 2 and 3 are separation plants sharing similar features (e.g., operable to separate only oil and gas, located in the Middle East) and similar historical data (e.g., a relatively low historical gas-to-oil ratio (GOR) suggesting oil-dominance, etc.). Similarly, the resource processor 310 may determine that inference entity 1 (e.g., x_{f1} in Table 4) is also similar to calibration entities 1, 2 and 3 (e.g., x_{c1}, x_{c2}, and x_{c3} in Table 1) on the basis of the vector embeddings associated therewith, and generally representing that the inference entity 1 and the calibration entities 1, 2 and 3 are separation plants sharing similar features (e.g., operable to separate only oil and gas, located in the Middle East) and similar historical data (e.g., a relatively low historical gas-to-oil ratio (GOR) suggesting oil-dominance, etc.). In contrast, the resource processor 310 may determine that experiment entities 1 and 4 (e.g., xₜ₁ and xₜ₄) are both similar to calibration entity 4 (e.g., x_{c4}) on the basis of the vector embedding associated therewith, and generally representing that the experiment entities 1 and 4 and the calibration entity 4 are separation plants sharing similar features (e.g., operable to separate oil gas and water, operable for very high pressure fluids, located in Texas, etc.) and similar historical data (e.g., relatively high historical GOR suggesting gas-dominance, etc.).

The actual k number of similar entities xₛ₁ . . . . xₛₖ may be determined based on a variety of different factors. For example, the k number may be based on one or more of parameters set when generating the vector index at block 408 above, such as a number of nodes in final leaf level of ANNOY or a number of nodes in a final cluster of IVF-flat. The k number may also be based on parameters set when querying the vector index at block 458, such a number of nearest neighbors or approximate nearest neighbors retrieved in response to a query of the vector index. The k number may also be based on the q number of calibration entities x_{c1} . . . . x_{cq} in the calibration set Z_{c}, the r number of experiment entities xₑ₁ . . . . xₑᵣ in the experiment set Zₑ, the n number of known entities in the entire known population of the plurality of entities 306, the p number of training entities xₜ₁ . . . . xₜₚ in the training set Zₜ used to train the value prediction model, a number of training entities used to train the vector embedding model, etc. For example, k may be approximately 150 when n is approximately 500000 or above.

For the k number of similar entities xₛ₁ . . . . xₛₖ to be useable in generating a conformal predictive distribution which calibrates a predicted value y in a more tailored manner than a conformal predictive distribution generated based on the entire population of known entities, the k number of similar entities xₛ is generally lower than the n number of known entities. For example, k may be at most 0.5*n, at most 0.25*n, or at most 0.1*n. Additionally, for the k number of similar entities xₛ₁ . . . . xₛₖ to be useable in generating a conformal predictive distribution which calibrates the predicted value y in a more tailored manner than a conformal predictive distribution generated based the entire population of calibration entities, the k number of similar entities xₛ₁ . . . . xₛₖ is also generally lower than the q number of calibration entities x_{c1} . . . . x_{cq}. For example, k may be at most 0.5*q, at most 0.25*q, or at most 0.1*q.

The k number of similar entities xₛ₁ . . . . xₛₖ identified for a particular entity x (alone or in combination with the particular entity x itself) forms an ad hoc entity category for that particular entity x. As a more concrete example, referring back to Tables 1 and 4 and the example described above, the ad hoc entity category for the experiment entity 3 (e.g., xₑ₃ in Table 4) includes the calibration entity 1, calibration entity 2 and calibration entity 2 (e.g., x (1) x_{c2}, and x_{c3}). Similarly, the ad hoc entity category for the inference entity 1 (e.g., x_{f1} in Table 4) includes the calibration entity 1, calibration entity 2 and calibration entity 2 (e.g., x_{c1}, x_{c2}, and x_{c3}). The ad hoc entity category for the experiment entity 1 (e.g., xₑ₁ in Table 4) includes at least the calibration entity 4 (e.g., at least x (4 in Table 1). The ad hoc entity category for the experiment entity 4 (e.g., xₑ₄ in Table 4) also includes at least the calibration entity 4 (e.g., at least x_{c4} in Table 1).

In some embodiments, the ad hoc entity category identified for a particular experiment entity xₑ may be identified and generated independently for each experiment entity of the experiment set Zₑ, such that each experiment entity xₑ₁ . . . . xₑᵣ may be associated with a corresponding ad hoc entity category. This may allow the predicted value yₑᵣ generated for each experiment entity xₑᵣ to be independently calibrated based on the ad hoc entity category of that experiment entity xₑᵣ. Similarly, the ad hoc entity category identified for a particular inference entity x_{f} may be identified and generated independently of other inference entities x_{f}, such that each inference entity x may be associated with its own corresponding ad hoc entity category. Additionally, in some embodiments, the ad hoc entity category (and the vector embeddings) may be generated for a particular entity x each time the value prediction model generates a predicted value y for that particular entity x (i.e., the ad hoc entity category identified for, and the vector embeddings associated with, a particular entity x may change over time). This may allow the predicted value y generated for each entity x (e.g., each experiment entity xₑ and/or each inference entity x_{f}) to be calibrated based on a current historical data and current features of that entity.

The generate calibrated predicted value process 450 then continues to block 460, which may include processor-executable codes directing the resource processor 310 to generate a conformal predictive distribution for a predicted value y generated for a particular entity x (e.g., generated at block 452) based at least in part on the calibration predicted values y_{c} of the calibration entities x_{c} which are identified as the similar entities xₛ₁ . . . . xₛₖ forming the ad hoc entity category identified for that particular entity x (e.g., identified at block 458). In this regard, the ad hoc entity category identified at block 458 may function as the Mondrian category k of a Mondrian conformal predictive system (see Boström, H., Johansson, U. & Löfström, T. (2021). Mondrian conformal predictive distributions. Proceedings of the Tenth Symposium on Conformal and Probabilistic Prediction and Applications, in Proceedings of Machine Learning Research, 152:24-38, incorporated by reference in its entirety herein). More specifically, block 460 may direct the resource processor 310 to produce, for a particular entity x, a list of calibration scores for the calibration entities xₛ₁ . . . . xₛₖ in the ad hoc entity category identified for that particular entity x using equation (1):

$${C}_{sk} = h ( x ) + \frac{\hat{σ}}{{\hat{σ}}_{sk}} ( {Y}_{sk} - h ( {x}_{sk} ) ) \qquad ( 1 )$$

where k represents a number of similar calibration entities xₛ in the ad hoc entity category, h(x) represents the predicted value y for the particular entity x generated using the value prediction model (e.g., yₑ or y_{f} values show in Table 2), Yₛₖ represents the calibration actual values (e.g., Y_{c} values shown in Table 3) for each corresponding calibration entity in the ad hoc entity category, h(xₛₖ) comprises the predicted value (e.g., y_{c} values show in Table 3) for each calibration entity in the ad hoc entity category generated using the value prediction model, \hat{σ}ₛₖ represents a difficulty estimate for each calibration entity in the ad hoc entity category (which may be generated using equation (2) below or may be set as a constant (e.g., 1, as the ad hoc entity category as a whole may provide a stable \hat{σ}ₛₖ for the calibration entities therein)) and ô represents a difficulty estimate for the particular entity x (which may also be generated using equation (2) below or may be set as a constant) (may be \hat{σ}ₑ in situations involving the experiment entity xₑ or \hat{σ}_{f} in situations involving the inference entity x_{f}).

$${\hat{σ}}_{i} = \{ \begin{matrix}\vert {n}_{i} \vert + β , & if 1 ( ∼ U ( 0 , 1 ) > ρ ) \\ \vert ∼ N ( 0 , 1 ) \vert + β , & otherwise\end{matrix} \qquad ( 2 )$$

where i represents different similar calibration entities xₛ in the ad hoc entity category or the entity x, ρ represents a level of randomness which may be pre-set (e.g., 0, 0.5, 1, etc.), and β represents power which may also be pre-set (e.g., 0.2, 0.1, 0.05, etc.).

For example, in the example described above where the ad hoc entity category for the experiment entity 3 (e.g., xₜ₃) includes the calibration entity 1, calibration entity 2 and calibration entity 3 (e.g., x_{c1}, x_{c2}, and x (3), block 460 may direct the resource processor 310 to generate a calibration score (e.g., C_{c1}, C_{c2}, and C_{c3}) of the experiment entity 3 relative to each of calibration entity 1, calibration entity 2 and calibration entity 3 using equation (1). Block 460 may then direct the resource processor 3102 sort the calibration scores Cₛᵢ in increasing order, resulting in Cₛ₍₁₎ . . . . Cₛ₍ₖ₎, and set Cₛ₍₀₎=−∞ and C_{s(q+1)}=0.

Block 460 may then direct the resource processor 310 to generate a conformal predictive distribution for a predicted value y of a particular entity x calibrated using the ad hoc entity category identified for that particular entity x using equation (3).

$$Q ( y ) = \{ \begin{matrix}\frac{n + r}{k + 1} , & if y ∈ ( {C}_{s ( n )} , {C}_{s ( n + 1 )} ) for n ∈ \{ 0 , … , k \} \\ \frac{{n}^{′} - 1 + ( {n}^{″} - {n}^{′} + 2 ) τ}{k + 1} , & if y = {C}_{s ( n )} for n ∈ \{ 1 , … , k \}\end{matrix} \qquad ( 3 )$$

$$where τ ∈ ⋃ ( 0 , 1 ) , {n}^{′} = min \{ m \vert {C}_{s ( m )} = {C}_{s ( n )} \} and {n}^{″} = max \{ m \vert {C}_{s ( m )} = {C}_{s ( n )} \} .$$

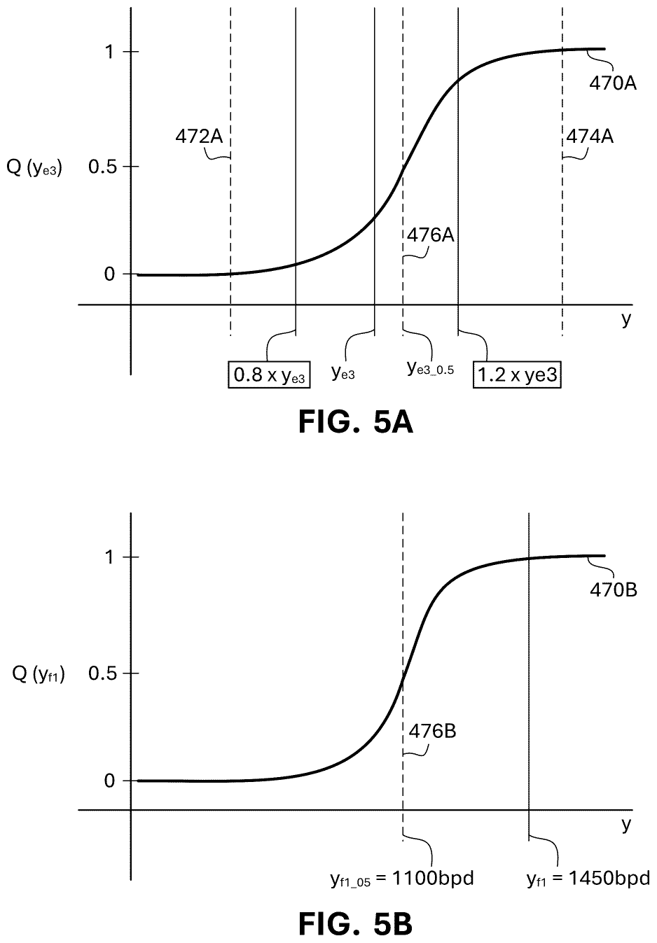

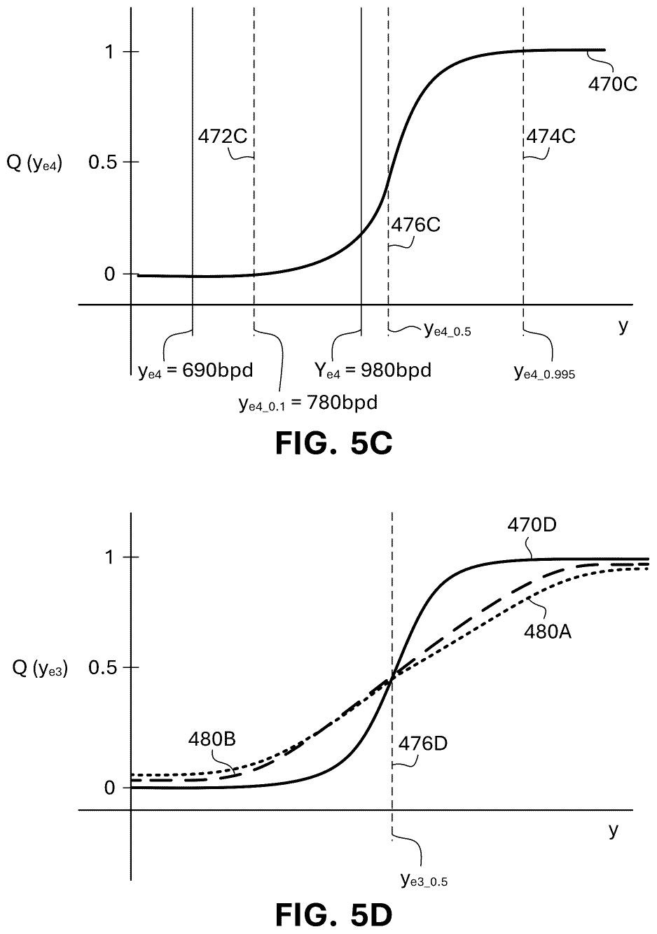

Referring to FIGS. 5A-5D, a conformal predictive distribution 470 generated with equation (3) may represent confidence intervals for the predicted value y generated for the entity x using the value prediction model.

Referring specifically to FIG. 5A, the conformal predictive distribution 470A may be used to determine values for the predicted value yₑ₃ generated for experiment entity 3 (e.g., xₑ₃) which fall within different percentiles, such as between a lower bound line 472A and an upper bound line 474A, and relative to a median bound line 476A. The lower and upper bound lines 472A and 474B may represent different percentiles based on a desired confidence level for the predicted value y. One skilled in the art will recognize that the lower and upper bound lines 472A and 474A may be selected and adjusted based on a desired confidence interval for the predicted value y. For example, for predicted values y requiring higher confidence level of e.g., 95%, the lower and upper bound lines 472A and 474B may correspond to a 0.025 percentile and a 0.975 percentile respectively (shown in FIG. 5A). In contrast, for predicted values y requiring a lower confidence level of e.g., 80%, the lower and upper bound lines 472A and 474B may instead correspond to a 0.1 percentile and a 0.90 percentile respectively. Generally, the median bound line 476A corresponds to a 0.5 percentile bound line.

Additionally, one skilled in the art will recognize that the upper and lower bound lines 472A and 474B may be adjusted independently of each other based on characteristics of the predicted value y, historical data and/or feature of the entity x and characteristics of the resource 308. For example, for resources 308 where more certainty is required for the upper range than the lower range of the predicted values y (e.g., in the example described above where the resource 308 is physical space in the oil reservoir, it may be desirable to overestimate the oil production rate of a particular gas-oil separation plant to prevent the possibility of overflow in the oil reservoir), the upper bound line 474A may be set at the 0.995 percentile while the lower bound line 472A may be set at the 0.2 percentile. In contrast, for resources 308 where more certainty is required for the lower range than the upper range of the predicted value y (e.g., in the example described above where the resource 308 is an number of units to stock, and where the entity x is an expensive writing instrument, it may be desirable to underestimate the units which will be sold to prevent the possibility that there will be remaining units which will not be sold), the upper bound line 474A may be set at the 0.6 percentile while the lower bound line 472A may be set at the 0.05 percentile.

The generate calibrated predicted value process 450 then continues to optional block 462, which may include processor-executable codes directing the resource processor 310 to adjust at least one of: (A) the predicted value y generated for the entity x (e.g., an experiment predicted value yₑ generated for a particular experiment entity xₑ and/or an inference predicted value y_{f1} generated for a particular inference entity x_{f}) based on the conformal predictive distribution generated at block 460 and (B) the confidence intervals generated for the predicted value y based on conformal predictive distributions which may be generated at block 460. In some embodiments, as an experiment entity xₑ is a part of the known entities and thus has an experiment actual value Yₑ, optional block 462 may also direct the resource processor 310 to adjust at least one of: (A) the experiment predicted value yₑ generated for the experiment entity xₑ, based on that experiment actual value Yₑ, and (B) the confidence intervals generated for the experiment predicted value yₑ, based on that experiment actual value Yₑ.

For example, a predicted value y generated for a particular entity x may be adjusted based on the conformal predictive distribution generated for that predicted value y in a wide variety of manners. In one example, the predicted value y may be adjusted relative to the median line 476 of the conformal predictive distribution 470 generated for that predicted value y. As a more specific example, referring to FIG. 5B, in some embodiments, the inference predicted value y_{f1} generated for inference entity 1 (e.g., x_{f1} shown in Table 2) may be higher than a median line 476B of the conformal predictive distribution 470B of that inference predicted value y_{f1}. This suggests that there may be a bias in the inference predicted values generated by the underlying value prediction model, as the value prediction model has a tendency to generate calibration predicted values y_{c} which are higher than the calibration actual values Y_{c} for the calibration entities in the ad hoc entity category identified for the inference entity 1 (i.e., entities that are similar to the inference entity 1). Block 462 may involve adjusting the initial inference predicted value y_{f1} (e.g., 1450 bpd) down to a median predicted value y_{f1_0.5} (e.g., 1100 bpd) at the median line 476B. Block 462 may also direct the resource processor 310 to adjust parameters of the value prediction model trained at block 404 to fine-tune the value prediction model, so that the value prediction model is more likely to output predicted values for the inference entity 1 x_{f1} which are closer to the median predicted value y_{f1_0.5} rather than the initial inference predicted value x_{f1}.

In another example, the predicted value y may be adjusted relative to the upper bound line 474 and/or the lower bound line 472 of the conformal predictive distribution 470 generated for that predicted value y. As a more specific example, a conformal predictive distribution 470C for the experiment predicted value yₑ₄ generated for experiment entity 4 (e.g., xₑ₄ shown in Table 2) is shown in FIG. 5C. The experiment predicted value yₑ₄ may be lower than a lower 0.1 percentile bound line 472C (e.g., 80% confidence interval) of the conformal predictive distribution 470C for the experiment predicted value yₑ₄. This again suggests that there may be a bias in the experiment predicted values generated by the underlying value prediction model, as the value prediction model has a tendency to generate calibration predicted values y_{c} which are lower than the calibration actual values Y_{c} for the calibration entities in the ad hoc entity category identified for experiment entity 4. Block 462 may involve adjusting the predicted value yₑ₄ (e.g., 690 bpd) up to the predicted value y_{e4_0.1} (e.g., 780 bpd) at the lower bound line 472C (rather than the median predicted value y_{e4_0.5} at the median line 476C) to provide a slight adjustment of the predicted value yₑ₄. Again, block 462 may also direct the resource processor 310 to adjust parameters of the value prediction model trained at block 404 further fine tune the value prediction model, so that the value prediction model is more likely to output predicted values for the experiment entity 4 xₑ₄ which are closer to the lower bound predicted value y_{e4_0.1} rather than the initial experiment predicted value yₑ₄. One skilled in the art will appreciate that there are other ways of adjusting a predicted value y based on the conformal predictive distribution generated for that predicted value y.

Similarly, an experiment predicted value yₑ generated for a particular experiment entity xₑ and the confidence intervals generated for that experiment predicted value yₑ may both be adjusted based on the experiment actual value Yₑ in a wide variety of manners. For example, referring again to FIG. 5C, the experiment predicted value yₑ₄ (e.g., 690 bpd) may be lower than the experiment actual value Yₑ₄ (e.g., 980 bpd). This again suggests that there may be a bias in the experiment predicted values generated by the value prediction model. Block 462 may involve adjusting the experiment predicted value yₑ₄ up to the experiment actual value Yₑ₄. Again, block 462 may also direct the resource processor 310 to adjust parameters of the value prediction model trained at block 404 further fine tune the value prediction model, so that the value prediction model is more likely to output predicted values for the experiment entity 4 xₑ₄ which are closer to the experiment actual value Yₑ₄ rather than the initial experiment predicted value yₑ₄.

As another example, still referring to FIG. 5C, the median line 476C (e.g., corresponding to a predicted value y_{e4_0.5}) of the conformal predictive distribution 470C for the experiment predicted value yₑ₄ is higher than the experiment actual value Yₑ₄ (e.g., 980 bpd). Block 462 may involve shifting the entire conformal predictive distribution 470C such that the median line 476C corresponds to the experiment actual value Yₑ₄, thereby adjusting the confidence intervals associated with the experiment predicted value yₑ₄. One skilled in the art will appreciate that there are other ways of adjusting an experiment predicted value yₑ and the confidence intervals generated for that experiment predicted value yₑ based on the experiment actual value Yₑ.

The conformal predictive distribution generated for a predicted value y for a particular entity x (e.g., an experiment predicted value yₑ generated for a particular experiment entity xₑ and/or an inference predicted value y_{f} generated for a particular inference entity x_{f}) may also be adjusted based on conformal predictive distributions generated for calibration predicted values yₛₖ for calibration entities xₛₖ which are in the ad hoc entity category identified for that particular entity x. For example, in some embodiments, the generate calibrated prediction value process 450 may also direct the resource processor 310 to perform block 458 and block 460 for at least one calibration entity xₛₖ in the ad hoc entity category identified for a particular entity x to (A) identified an ad hoc entity category for the calibration entity xₛₖ (e.g., at block 458) and (B) generate a calibration conformal predictive distribution for a calibration predicted value yₛₖ for the calibration entity xₛₖ based on the ad hoc entity category identified for the calibration entity xₛₖ. This may be performed for multiple calibration entities xₛₖ in the ad hoc entity category identified for the particular entity x, to generate multiple calibration conformal predictive distributions (and multiple comparable calibration difficulty estimates \hat{σ}ₛₖ). The multiple calibration conformal predictive distributions may then be used to adjust the conformal predictive distribution for the initial for the particular entity x. In other words, block 462 may involve adjusting the conformal predictive distribution for a particular entity x based on the conformal predictive distribution for entities that are similar to that particular entity x.

For example, referring now to FIG. 5D, a calibration conformal predictive distribution 480A for a calibration entity A (e.g., x_{sA}) and a calibration conformal predictive distribution 480B for calibration entity B (e.g., x_{sB}) may be overlain a conformal predictive distribution 470D for the experiment entity 3 (e.g., xₑ₃ shown in Table 2), centered on the median line 476D of the conformal predictive distribution 470D. The calibration entities A and B may be in the ad hoc entity category identified for experiment entity 3. Based on this overlay, the calibration conformal predictive distributions 480A and 480B are flatter than the conformal predictive distribution 470C (e.g., calibration difficulty estimates \hat{σ}_{sA} and \hat{σ}_{sB} are higher than difficulty estimate \hat{σ}ₑ₃, thereby resulting in larger confidence intervals). This suggests that the conformal predictive distribution 470C generated for the experiment entity 4xₑ₄ may be over optimistic (e.g., too narrow), as the calibration conformal predictive distributions 480A and 480B for the calibration entities A and B (i.e., for entities that are similar to the experiment entity 4) both have larger confidence intervals. Block 462 may involve adjusting the difficulty estimate \hat{σ}ₑ₄ for the predicted value yₑ₄ based on the calibration difficulty estimates \hat{σ}_{sA} and \hat{σ}_{sB} (e.g., average, median, etc.) to flatten the conformal predictive distribution 470C. Again, block 462 may also direct the resource processor 310 to adjust parameters of the value prediction model at block 404 to further fine tune the value prediction model based on the adjusted difficulty estimate \hat{σ}ₑ₄.

The generate calibrated predicted value process 450 then continues to block 464, which may include processor-executable codes directing the resource processor 310 to provide access to the resource 308 to a particular entity x based on the confidence intervals for the predicted value y generated for that particular entity x (e.g., an experiment predicted value yₑ generated for a particular experiment entity xₑ and/or an inference predicted value y_{f} generated for a particular inference entity x_{f}).

In some embodiments, block 464 may direct the resource processor 310 to determine a rating of a particular entity x based on the confidence intervals for a predicted value y generated for that particular entity x. In particular, entities x may be classified into a plurality of rating bins (rating bins 1 to 6 are shown in Tables 5 and 6 below) based on the corresponding confidence intervals for the corresponding predicted values y. In some embodiments, the rating of a particular entity x may correspond to a risk level or a level of uncertainty associated with that particular entity x.

As a first example, block 464 may involve determining how much the predicted value y will vary within a pre-set confidence interval (e.g., coverage). More specifically, block 464 may involve determining a predicted value at one or more of the lower and upper bound lines 472 and 474 (e.g., in embodiments where the pre-set confidence level is 95%, the predicted value at the lower bound line 472 may correspond to a 0.025 predicted value y_{0.025} and the predicted value at the upper bound line 474 may correspond to a 0.975 predicted value y_{0.975}). In some embodiments, the rating of an entity x may be based on the actual value of these predicted values, and may be based on a comparison of the predicted values to a defined threshold. For example, in the examples described above where the entity x comprises a gas-oil separation plant, the resource 308 comprises space in an oil reservoir, and the predicted value y comprises a rate of oil production (bpd), block 464 may associate a particular separation plant with lower ratings (e.g., less risk) if upper predicted value y_{0.975} is below a particular defined threshold (e.g., 500 bpd) and higher ratings as the upper predicted value y_{0.975} increases.

In other embodiments, these upper and lower predicted values may be further processed to determine a rating of the particular entity. In some embodiments, the upper and lower predicted values may be processed relative to each other to determine the total value range as therebetween. The rating of an entity x may be based on this total value range, and may be based on a comparison of this total value range to a defined threshold. For example, again referring to the examples described above where the entity x comprises a gas-oil separation plant and the resource 308 comprises space in an oil reservoir, block 464 may associate a particular separation plant with lower ratings if the total value range is below a defined threshold (e.g., 50 bpd), and higher ratings as the total value increases.

In yet other embodiments, the upper and lower predicted values may be processed relative to the predicted value y generated by the value prediction model. For example, block 464 may further involve determining a percentage of these predicted values at the lower and upper bound lines 472 and 474 relative to the predicted value y generated at block 452 or modified at block 462 (e.g., y_{0.025}/y or y/y_{0.975}) 75). As the calculated upper bound percentage (e.g., y/y_{0.975}) increases, and/or the calculated lower bound percentage (e.g., y_{0.975}/y) decreases, the error associated with the predicted value y may correspondingly increase. In this regard, referring to Table 5, entities x (e.g., a particular experiment entity xₑ and/or a particular inference entity x_{f}) may be associated with higher ratings as the calculated error increases. One of ordinary skill in the art will appreciate that either the upper bound percentage or the lower bound percentage (or a combination thereof) may be used to determine the rating associated with a particular entity x.

TABLE 5
Example 1: ratings based on confidence
interval of the predicted value y

| Rating | y_{0.025}/y | y/y_{0.975}. |
|---|---|---|
| 1 | >0.01 | >0.9 |
| 2 | 0.02-0.05 | 0.89-0.80 |
| 3 | 0.06-0.10 | 0.79-0.70 |
| 4 | 0.11-0.20 | 0.69-0.60 |
| 5 | 0.21-0.30 | 0.59-0.50 |
| 6 | 0.31-0.40 | 0.49-0.40 |

[ . . . ]

As another example, block 464 may instead involve determining a predicted likelihood that that the predicted value y will vary by a pre-set variance percentage based on the confidence intervals generated for the predicted value y. More specifically, block 464 may involve (A) determining upper and lower bound predicted values based on a pre-set variance percentage (e.g., in embodiments where the pre-set variance percentage is 20%, the lower bound predicted value may be 0.8*y and the upper bound predicted value may be 1.2*y; in embodiments where the pre-set variance percentage is 50%, the lower bound predicted value may be 0.5*y and the upper bound predicted value may be 1.5*y; etc.) and (B) determining the confidence interval percentile associated with the upper and lower bound predicted values. For example, referring to FIG. 5A, the lower bound predicted value 0.8*yₑ₃ may be associated with a confidence interval percentile of −0.12 and the upper bound predicted value 1.2*yₑ₃ may be associated with a confidence interval percentile of +0.09. As the confidence interval percentiles between the predicted value y and the upper and lower bound predicted values increase, the error in the predicted value y may correspondingly increase. In this regard, referring to Table 6 below, experiment entities may be associated with higher ratings as the calculated error increases. One of ordinary skill in the art will appreciate that either the confidence interval percentile associated with the upper bound predicted value or the confidence interval percentile associated lower bound predicted value (or a combination thereof) may be used determine the rating associated with an entity x.

TABLE 6
Example 2: ratings based on confidence
interval of the predicted value

| | Confidence interval at | Confidence interval at |
|---|---|---|
| | lower bound predicted | upper bound predicted |
| Rating | value (0.8 * y) | value (1.2 * y) |
| 1 | <0.1 | <0.1 |
| 2 | 0.11-0.20 | 0.11-0.20 |
| 3 | 0.21-0.30 | 0.21-0.30 |
| 4 | 0.31-0.40 | 0.31-0.40 |
| 5 | 0.41-0.50 | 0.41-0.50 |
| 6 | 0.51-0.60 | 0.51-0.60 |

[ . . . ]

In some embodiments, block 464 may direct the resource processor 310 to determine a rating of for a particular entity x based on both the confidence intervals for a predicted value y generated for that particular entity x and the actual value of the predicted value y itself. In particular, entities x may be classified into a plurality of rating bins (rating bins 1 to 3 are shown in Table 7 below) based on a combination of the confidence intervals for the corresponding predicted values y and the actual value of the corresponding predicted values y.

For example, a large predicted value y may be associated with a larger confidence interval (i.e., more error) and be given a particular rating, whereas a small predicted value y may require a smaller confidence interval (i.e., less error) in order to be given that same particular rating (or vice versa). In this regard, referring to Table 7 below, entities x may be associated with higher ratings for higher predicted values y and lower ratings for lower predicted values y.

TABLE 7
Ratings based on confidence interval of the predicted
value y and the actual value of the predicted value y

| | Confidence interval at lower | |
|---|---|---|
| | bound predicted value | Predicted |
| Rating | (0.8 * y) | value (y) |
| 1 | 0.11-0.20 | >1000 bpd |
| 1 | <0.1 | <1000 bpd |
| 2 | 0.21-0.30 | >1000 bpd |
| 2 | 0.11-0.20 | <1000 bpd |
| 3 | 0.31-0.50 | >1000 bpd |
| 3 | 0.21-0.30 | <1000 bpd |

[ . . . ]

In some embodiments, block 464 may direct the resource processor 310 to provide access to the resource 308 based on the rating associated with a particular entity x. For example, if the rating of a particular entity x is above a defined rating threshold, block 464 may involve providing that entity x with access to the resource 308, whereas if the rating of that entity x is below the defined rating threshold, block 464 may involve denying that entity x access to the resource 308. As a more concrete example, the defined rating threshold may be “5.” If block 464 determines that a particular entity x has a rating 5 or below, block 464 may provide that entity x with access to the resource 308 in response to receiving an access request from an entity device 304 associated with that entity x. However, if at block 464 determines that the entity x has a rating of 6 or the above, block 464 may instead deny the entity x access to the resource 308 in response to receiving an access request from an entity device 304 associated with that entity x. In such embodiments, the amount of the resource 308 provided may be based on the predicted value y generated at block 452 or adjusted at block 462 as described above.

In other embodiments, block 464 may direct the resource processor 310 to provide access to the resource 308 based on a combination of the rating associated with a particular entity x and and the actual value of the predicted value y itself. In such embodiments, each rating (e.g., each rating bin described above) may be associated with a different defined threshold. For example, if the rating of a particular entity x is 1, block 464 may involve providing that entity x with access to the resource 308 if the actual value of the predicted value y is >500 bpd, but denying that entity x access to the resource 308 if the actual value of the predicted value y is ≤500 bpd (in which case 500 bpd comprises the defined threshold associated with the rating bin 1). However, if the rating of a particular entity x is 5, block 464 may involve providing that entity x with access to the resource 308 if the actual value of the predicted value y is >700 bpd, but denying that entity x access to the resource 308 if the actual value of the predicted value y is ≤700 bpd (in which case 700 bpd comprises the defined threshold associated with the rating bin 3).

In some embodiments, block 464 may direct the resource processor 310 to provide access to the resource 308 to an entity x automatically based on the rating of the rating of the entity x. For example, where the entity x comprises a gas-oil separation plant, the resource 308 comprises space in an oil reservoir, and the predicted value y comprises a rate of oil production (bpd), block 464 may direct the resource processor 310 to automatically actuate a valve associated with the oil reservoir to receive the oil from the separation plant when the rating associated with the separation plant is higher than the defined threshold. As a further example, where the entity x is a writing instrument and the resource 308 is a number of units to stock, block 464 may direct the resource processor 310 to automatically order an amount of units of the writing instrument (e.g., based on the predicted value y corresponding to a predicted number of units to be sold) when the rating associated with the writing instrument is higher than the defined threshold.

The generate calibrated predicted value process 450 then ends. One skilled in the art will appreciate that the above methodology can be applied to any entity 306 and any resource 308. For example, as briefly described above, the plurality of entities 306 may comprise a plurality of online e-commerce stores, the resource 308 may comprise financial resources to be extended to a particular e-commerce store, and the predicted value y may correspond a predicted future GMV (e.g., over a forecasted period of time) for that particular e-commerce store. The predicted future GMV may be indicative of the ability of that particular e-commerce store to return the extended capital resources. As another example, as also described above, the plurality of entities 306 may instead comprise a plurality of entity devices 304 associated with specific employees, the resource 308 may comprise secured documents which will be accessed by a particular employee, and predicted value y may correspond a predicted likelihood of a cyber-attack on a particular employee. The predicted likelihood of a cyber-attack may be indicative of the security of the entity device 304 associated with the particular employee. One skilled in the art will also appreciate that the above methodology can be applied to any a predicted value generated by any value prediction model (e.g., any regression model).

### CONCLUSION

The person skill in the art will appreciate that many variations to the embodiments described in the present document art possible and will become apparent from a reading of the present document concurrently with the figures.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about”, “substantially” or “approximately” shall generally mean within the error margin generally accepted in the art. Hence, numerical quantities given herein generally include such error margin such that the terms “around”, “about” “substantially” or “approximately” can be inferred if not expressly stated. For greater clarity, unless otherwise explicitly stated, the terms “around”, “about”, “substantially” and “approximately” means a proportion of at least about 60%, or at least about 70% or at least about 80%, or at least about 90%, at least about 95%, at least about 97% or at least about 99% or more, or any integer between 70% and 100%.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although various embodiments of the invention have been described and illustrated, it will be apparent to those skilled in the art in light of the present description that numerous modifications and variations can be made. The scope of the invention is defined more particularly in the appended claims.

1. A computer-implemented method comprising:
receiving a request for access to a resource from an entity device associated with an entity;
inputting historical data associated with the entity into a value prediction model trained to output a predicted value for the entity;
processing a vector embedding associated with the entity to identify an ad hoc entity category associated with the entity, wherein the ad hoc entity category includes at least one other entity similar to the entity;
generating a conformal predictive distribution for the predicted value based at least in part on entities in the ad hoc entity category, where the conformal predictive distribution represents a confidence interval of the predicted value; and
providing access to the resource based on the confidence interval of the predicted value.

2. The computer-implemented method of claim 1, further comprising:
generating vector embeddings associated with each calibration entity of a plurality of calibration entities; and
processing the vector embeddings associated with each calibration entity to generate a vector index, wherein processing the vector embedding associated with the entity comprises querying the vector index with the vector embedding associated with the entity.

3. The computer-implemented method of claim 2, wherein processing the vector embeddings associated with each calibration entity to generate the vector index comprises determining nearest neighbors for each calibration entity to generate the vector index.

4. The computer-implemented method of claim 2, wherein querying the vector index with the vector embedding associated with the entity comprises:
querying the vector index with the vector embedding associated with the entity to identify a k number of calibration entities of the plurality of calibration entities which are similar to the entity.

5. The computer-implemented method of claim 4, wherein the k number of calibration entities form the entities in the ad hoc entity category.

6. The computer-implemented method of claim 1, wherein the entities in the ad hoc entity category are selected based on similarity determined by vector embeddings associated with each entity of the entities in the ad hoc entity category.

7. The computer-implemented method of claim 1, further comprising:
inputting second historical data associated with a second entity into the value prediction model trained to output a second predicted value associated with the second entity;
processing a second vector embedding associated with the second entity to determine a second ad hoc entity category associated with the second entity, wherein entities in the second ad hoc entity category is different from the entities in the ad hoc entity category; and
generating a second conformal predictive distribution for the second predicted value based at least in part on the entities in the second ad hoc entity category, where the second conformal predictive distribution represents a second confidence interval of the second predicted value and where the second confidence interval of the second predicted value is different from the confidence interval of the predicted value.

8. The computer-implemented method of claim 1, wherein generating the conformal predictive distribution for the predicted value based at least in part on the entities in the ad hoc entity category comprises:
generating the conformal predictive distribution for the predicted value based at least in part on corresponding predicted values associated with each entity of the entities in the ad hoc entity category, wherein the corresponding predicted values are outputted by the value prediction model.

9. The computer-implemented method of claim 8, further comprising:
determining a rating of the entity based on the confidence interval of the predicted value.

10. The computer-implemented method of claim 9, wherein providing access to the resource comprises providing access to the resource based on the rating of the entity.

11. The computer-implemented method of claim 10, wherein providing access to the resource is performed automatically based on the rating of the entity.

12. The computer-implemented method of claim 10, wherein providing access to the resource based on the rating of the entity is based on a comparison to a defined threshold, the computer-implemented method further comprising:
providing access to the resource when the rating of the entity is above the defined threshold; and
denying access to the resource when the rating of the entity is below the defined threshold.

13. The computer-implemented method of claim 9, wherein determining the rating of the entity comprises classifying the entity into one of a plurality of rating bins on at least the confidence interval of the predicted value for the entity.

14. The computer-implemented method of claim 13, wherein providing access to the resource based on the rating of the entity is based on a comparison of the rating of the entity to a defined threshold, wherein the defined threshold is different for different rating bins of the plurality of rating bins.

15. The computer-implemented method of claim 9, wherein the rating of the entity corresponds to a risk level of the entity.

16. The computer-implemented method of claim 15, wherein the risk level increases as the confidence interval of the predicted value increases.

17. A system comprising:
at least one processor; and
a computer-readable medium in communication with the at least one processor, the computer-readable medium storing computer-executable instructions that, when executed, cause the at least one processor to at least:
receive a request for access to a resource from an entity device associated with an entity;
input historical data associated with the entity into a value prediction model trained to output a predicted value for the entity;
process a vector embedding associated with the entity to determine an ad hoc entity category associated with the entity, wherein the ad hoc entity category includes at least one other entity similar to the entity;
generate a conformal predictive distribution for the predicted value based at least in part on entities in the ad hoc entity category, where the conformal predictive distribution represents a confidence interval of the predicted value; and
provide access to the resource based on the confidence interval of the predicted value.

18. The system of claim 17, wherein the computer-readable medium further stores processor-executable instructions that cause the at least one processor to:
generate vector embeddings associated with each calibration entity of a plurality of calibration entities; and
process the vector embeddings associated with each calibration entity to generate a vector index, wherein processing the vector embedding associated with the entity comprises querying the vector index with the vector embedding associated with the entity.

19. The system of claim 18, wherein the processor-executable instructions which cause the at least one processor to query the vector index with the vector embedding associated with the entity comprises processor-executable instructions that cause the at least one processor to:
query the vector index with the vector embedding associated with the entity to identify a k number of calibration entities of the plurality of calibration entities which are similar to the entity.

20. A non-transitory computer-readable storage medium having stored thereon computer-executable instructions that, when executed, cause a computer to:
receive a request for access to a resource from an entity device associated with an entity;
input historical data associated with the entity into a value prediction model trained to output a predicted value for the entity;
process a vector embedding associated with the entity to determine an ad hoc entity category associated with the entity, wherein the ad hoc entity category includes at least one other entity similar to the entity;
generate a conformal predictive distribution for the predicted value based at least in part on entities in the ad hoc entity category, where the conformal predictive distribution represents a confidence interval of the predicted value; and
provide access to the resource based on the confidence interval of the predicted value.
